(19) United States
(12) Patent Application Publication
(10) Pub. No.: US 2014/0215352 A1
(43) Pub. Date: Jul. 31, 2014

(54) SYSTEM AND METHOD FOR PINNABLE CHAT MESSAGE

(71) Applicants: Stéphane Blecon, Bohars (FR); Boris Nicolas, Gouesnou (FR)

(72) Inventors: Stéphane Blecon, Bohars (FR); Boris Nicolas, Gouesnou (FR)

(21) Appl. No.: 13/753,376

(22) Filed: Jan. 29, 2013

(51) Int. Cl. H04L 12/58

(52) U.S. Cl. CPC H04L 51/046
USPC 715/752

(57) ABSTRACT

A user interface for chat sessions. A user may designate, or pin, one or more messages sent or received during a chat session to be displayed for the duration of the chat session, while other messages may scroll off of the top of the chat window transcription area. Designated messages may be displayed, for example, at the top or bottom of the transcription area, or in a separate window.

### FIELD

The field is digital communication using computerized appliances over networks, and the disclosure pertains more particularly to communication by chat applications.

### BACKGROUND

Chat functionality, and other forms of text-bases interaction, such as Instant Messaging (IM) and Short Message Service (SMS) are well known in the art, provide by software execution text-based communication between two persons operating computerized appliances over a network connection. Using chat as an example, in a chat session each party has a composition field in which that person may compose a message, and a send button that will cause the message to be sent to the other party. Once a composed message is sent it will appear in a transcript area, wherein alternate messages are listed with identity of the person who composed each message.

Chat is a useful tool for transactions between, for example, an agent of a contact center and customers of such a contact center. The agent may carry on more than one session at a time, and separate transcripts will be displayed to the agent, one for each customer session. Each customer engaged in a session with the agent will also see a transcript of shared messages.

Chat sessions may be lengthy, with transcripts going beyond the ability of a static window to record and display, so scroll capability may be provided so each party to a session may scroll back and forward in the transcript. In a lengthy session with a long transcript there may often be one or more messages that are more important than others, and to which one or both of the parties may wish to refer, perhaps frequently, during a session. The present disclosure teaches a unique solution to such difficulty.

### SUMMARY

An aspect of an embodiment of the present invention is directed toward a user interface for chat sessions, in which a user may designate, or pin, one or more messages sent or received during a chat session to be displayed for the duration of the chat session, while other messages may scroll off of the top of the chat window transcription area. Designated messages may be displayed, for example, at the top or bottom of the transcription area, or in a separate window.

According to an embodiment of the present invention there is provided a method, including: displaying by a computerized appliance having a processor, a text communication window having a message composition field, a mechanism for initiating a send command for a composed message, and a message transcription area for displaying messages sent and received; initiating a messaging session, wherein messages sent and received during the messaging session are displayed serially in the transcription area until the session terminates; and providing a user-selectable mechanism for designating one or more messages to be displayed throughout the messaging session.

In one embodiment, the method includes: displaying one or more designated messages in a first portion of the transcription area and marking the designated messages uniquely for differentiating the one or more designated messages from other messages displayed in the transcription area.

In one embodiment, the method includes: displaying one or more designated messages in a space-limited region of the transcription area provided with a scrolling mechanism for scrolling through the one or more designated messages in response to user actuation of the scrolling mechanism.

In one embodiment, the method includes: displaying one or more designated messages in a separate, floating window, moveable by drag-and-drop.

In one embodiment, the method includes: providing a scrolling mechanism for scrolling through the one or more designated messages in the floating window in response to user actuation of the scrolling mechanism.

In one embodiment, the method includes: identifying a single word or phrase in a composed message for displaying the word or phrase throughout the messaging session.

According to an embodiment of the present invention there is provided a chat interface apparatus, including: a processor and a memory, the memory storing instructions that, when executed by the processor, cause the processor to display: a text communication window having a message composition field; a user control for initiating a send command for a message composed; and a message transcription area showing messages sent and received. The instructions further cause the processor to initiate a messaging session; display messages sent and received serially in the transcription area until the session terminates; and provide a user-selectable mechanism for designating one or more messages to be displayed throughout the messaging session.

In one embodiment, the memory further stores instructions that, when executed by the processor, cause the processor to: display one or more designated messages in a first portion of the transcription area; and mark the one or more designated messages uniquely for differentiating the one or more designated messages from other messages displayed in the transcription area.

In one embodiment, the memory further stores instructions that, when executed by the processor, cause the processor to: display one or more designated messages in a space-limited region of the transcription area provided with a scrolling mechanism for scrolling through the one or more designated messages in response to user actuation of the scrolling mechanism.

In one embodiment, the memory further stores instructions that, when executed by the processor, cause the processor to: display one or more designated messages in a separate, floating window, moveable by drag-and-drop.

In one embodiment, the memory further stores instructions that, when executed by the processor, cause the processor to: provide a scrolling mechanism for scrolling through the one or more designated messages in the floating window in response to user actuation of the scrolling mechanism.

In one embodiment, the memory further stores instructions that, when executed by the processor, cause the processor to: identify a single word or phrase in a composed message for displaying the word or phrase throughout the messaging session.

### BRIEF DESCRIPTION OF THE DRAWINGS

FIG. 1a is an illustration of a chat window in one implementation at one time point in a chat session.

FIG. 1b is an illustration of a chat window in the implementation of FIG. 1a at a different time point in the chat session.

FIG. 1c is an illustration of a floating window with a chat session in one implementation.

### DETAILED DESCRIPTION

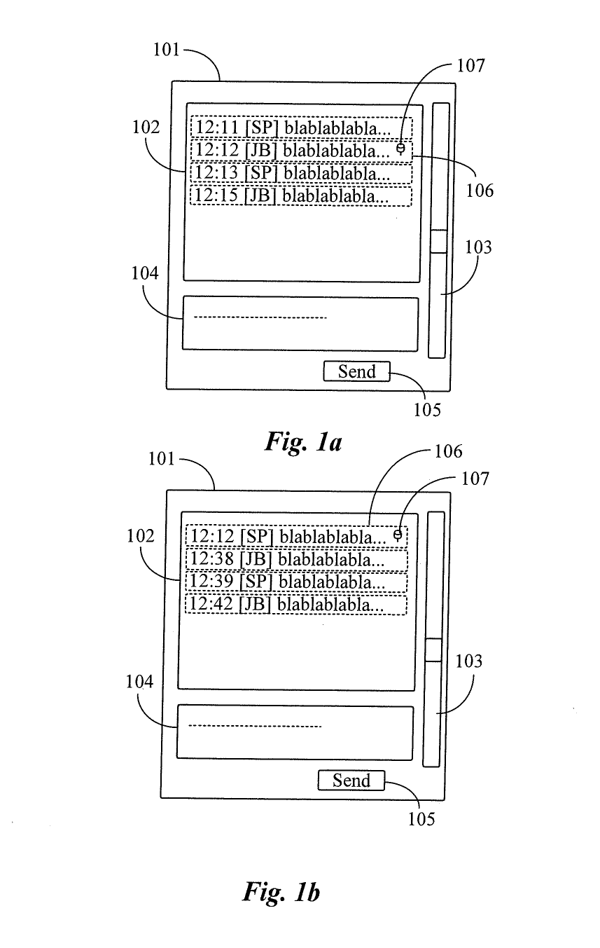

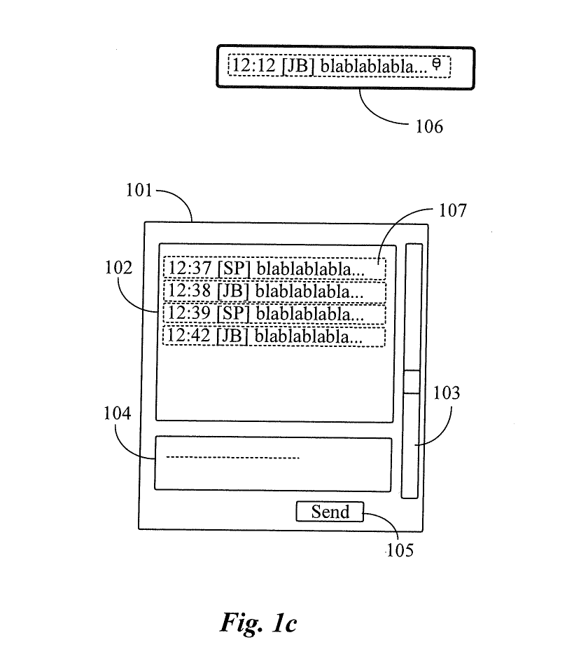

Referring now to FIG. 1a, a chat window 101 is illustrated having a transcript area 102, a scroll mechanism 103 allowing a user to scroll the transcript, a composition field 104 within which a user may compose a message, a Send button 105, which when used may cause the message composed in field 104 to be sent to the opposite party in the chat session, and a pinned message 106 in the transcript, indicated by a pin symbol 107.

Mechanisms are provided in different implementations of the invention for a participant to pin a message. In one implementation a participant may realize during composition that the message should be pinned, and the participant may cause the message to be pinned by one or another of a specific key sequence, such as Control-*, i.e., the key sequence consisting of holding the “Ctrl” and “Shift” keys while pressing the “8” key. In another implementation the pin command may be exercised by right click and selecting PIN from a drop-down menu. In yet another implementation there may be an audio command prompt recognizing the word phrase “Pin it”. There may be several ways of initiating the pin command, and more than one way may be active at any time.

In another implementation the participant may realize at a later time, after a message has been sent for example, and appears in the transcript area, that he or she wishes that message to be pinned. At that point the participant may, for example, highlight the message, or select it in another fashion, and then initiate the pin command by any of the mechanisms described above.

FIG. 1b illustrates the chat session of FIG. 1 at a later time, wherein messages are indicated in the transcript to have been added to the transcript long after the time of pinned message 106. Although the chat dialogue may have continued for a considerable time, to a point far beyond where message 106 would normally be displayed in the transcript without scrolling, message 106, with identity and time, is still displayed at the head (in this case) of the transcript list. In other implementations the pinned message may be displayed at the bottom of the transcript area, and may be indicated by pale highlighting rather than by pin symbol 107. Pin status may be indicated for a message in a number of different ways. This may be by as symbol such as symbol 107, by highlighting as described above, or in some other manner, such as text color, a different and distinct font, a color border, or in some other way.

In some implementations a pinned message may be displayed in the transcript area, in line with other messages in the transcript, but may not necessarily occupy space for another message. In this implementation the pinned message may be rendered transparent so other messages may be discerned beneath the pinned message.

FIG. 1c illustrates another implementation in which a pinned message may be displayed differently than in the implementation referring to FIG. 1b. In this implementation pinned message 106 is implemented in a floating window, which may be positioned by click and drag, for example, by a participant. In this implementation the floating window may also be transparent, so if the participant were to position it over a part of the chat window, it would not completely obscure other parts of the chat.

In implementations of the invention a user is not limited to pinning a single message. A user may select two or more messages to pin. In some implementations, if a user selects a second or subsequent message to pin, the pinned messages will appear in order, with pin symbols where applicable, and in case of a relatively long list of pinned messages, a scrolling capability may be provided.

In some implementations a user may wish to pin just a part of a message, or even a single word. In this case a mechanism may be provided for a user to select a word or a phrase in a message, either in the composition field, or in the transcript, and then initiate the pin command by whichever mechanism is enabled for the pin command.

A user who has pinned one or more messages may also wish to Unpin one or more of the pinned messages. In some implementations a mechanism is provided for Unpinning, which may be similar to the pin command. For example, the user may select a pinned message, right click, and select an Unpin command. Assigned keystrokes may be provided for the same purpose, as well as a voice command.

The unique solutions taught in the present specification are not limited to chat, but may be applied equally well to Instant Messaging (IM) and Short Message Service (SMS) transactions.

What is claimed is:

1. A method for providing a chat interface, comprising:
displaying by a computerized appliance having a processor, a text communication window having a message composition field, a mechanism for initiating a send command for a composed message, and a message transcription area for displaying messages sent and received;
initiating a messaging session, wherein messages sent and received during the messaging session are displayed serially in the transcription area until the session terminates; and
providing a user-selectable mechanism for designating one or more messages to be displayed throughout the messaging session.

2. The method of claim 1 further comprising:
displaying one or more designated messages in a first portion of the transcription area and marking the designated messages uniquely for differentiating the one or more designated messages from other messages displayed in the transcription area.

3. The method of claim 1 further comprising:
displaying one or more designated messages in a space-limited region of the transcription area provided with a scrolling mechanism for scrolling through the one or more designated messages in response to user actuation of the scrolling mechanism.

4. The method of claim 1 further comprising:
displaying one or more designated messages in a separate, floating window, moveable by drag-and-drop.

5. The method of claim 4 further comprising:
providing a scrolling mechanism for scrolling through the one or more designated messages in the floating window in response to user actuation of the scrolling mechanism.

6. The method of claim 1 further comprising:
identifying a single word or phrase in a composed message for displaying the word or phrase throughout the messaging session.

7. A chat interface apparatus, comprising:
a processor and a memory, the memory storing instructions that, when executed by the processor, cause the processor to:
display:
a text communication window having a message composition field;
a user control for initiating a send command for a message composed; and
a message transcription area showing messages sent and received;
initiate a messaging session;
display messages sent and received serially in the transcription area until the session terminates; and
provide a user-selectable mechanism for designating one or more messages to be displayed throughout the messaging session.

8. The apparatus of claim 7, wherein the memory further stores instructions that, when executed by the processor, cause the processor to:
display one or more designated messages in a first portion of the transcription area; and
mark the one or more designated messages uniquely for differentiating the one or more designated messages from other messages displayed in the transcription area.

9. The apparatus of claim 7, wherein the memory further stores instructions that, when executed by the processor, cause the processor to:
display one or more designated messages in a space-limited region of the transcription area provided with a scrolling mechanism for scrolling through the one or more designated messages in response to user actuation of the scrolling mechanism.

10. The apparatus of claim 7, wherein the memory further stores instructions that, when executed by the processor, cause the processor to:
display one or more designated messages in a separate, floating window, moveable by drag-and-drop.

11. The apparatus of claim 10 wherein the memory further stores instructions that, when executed by the processor, cause the processor to:
provide a scrolling mechanism for scrolling through the one or more designated messages in the floating window in response to user actuation of the scrolling mechanism.

12. The apparatus of claim 7 wherein the memory further stores instructions that, when executed by the processor, cause the processor to:
identify a single word or phrase in a composed message for displaying the word or phrase throughout the messaging session.
